(19) United States
(12) Patent Application Publication
(10) Pub. No.: US 2023/0270268 A1
(43) Pub. Date: Aug. 31, 2023

(54) Method and Apparatus for Improved Blanket Utility

(71) Applicant: Paul Hoang Pham, Orange, CA (US)

(72) Inventor: Paul Hoang Pham, Orange, CA (US)

(21) Appl. No.: 18/159,052

(22) Filed: Jan. 24, 2023

Related U.S. Application Data
(60) Provisional application No. 63/304,552, filed on Jan. 28, 2022.

(51) Int. Cl. A47G 9/02

(52) U.S. Cl. CPC A47G 9/023; A47G 9/0223

(57) ABSTRACT

A modular blanket comprising of separate blanket materials of varying size and fastening mechanisms including buttons and zippers. The blanket may be comprised of traditional blanket material such as wool or cloth and be used for standard purposes of warmth or comfort. Additionally, the blanket may be comprised other material such as fiberglass, to be used for commercial or public purposes, such as the extinguishing of a fire. The fastening mechanisms including, but not limited to buttons or zippers are attached along the lateral sides of such blanket material to allow quick and easy assembly and disassembly.

### FIELD OF INVENTION

The present invention relates generally to the field of coverings, and more specifically the field of blankets.

### PRIOR ART

Blankets in general are typically large pieces of material used as a bed covering or as a warmth retainer. Blankets can be made from fabrics, textiles, synthetics, fibers, or other various materials affixed together. Blankets are often used on humans or domestic animals for the primary purpose of covering one's body at night to retain warmth, allowing one to have a better night's sleep. Physically, they also provide protection from the elements, such as cold weather involving wind or snow by providing an additional barrier between the skin and outside environment. Psychologically, they provide a sense of comfort and shelter away from the harshness of the outside world. For humans, this often involves placing the blanket on one's bed of choice during the day, presenting it in a neat manner, and using it by covering the body before sleeping at a desired time. For domestic animals, such as dogs or cats, it is often used by placing such a blanket on top of a dog or cat bed and leaving it there throughout the day.

Since the advent of the modern blanket in the 14th century, there have been many slight modifications and alterations to it. For example, there have been many divergences in the types of blankets seen in use such as the introduction of comforters, throws, duvets, quilts, sherpa blankets, etc. These examples of divergent blankets were innovated to merely change the feel and style of the blanket, as some instituted new additions such as the placement of goose feathers within the fabric of the blanket. Such blankets also deviated from the original modern blanket by incorporating or substituting the typical cloth with wool, mink, fleece, cotton, woven acrylic, knitted polyester, etc. Furthermore, blankets had begun to take forms in mediums such as art and culture, in which the textured patterns and methods of blanket creation became the newly developed aspects. These included creations ranging from Navajo blankets to Basotho blankets, which not only further developed the luxury commercial blanket industry, but also began to establish certain utility in blankets, namely the wearability of them.

From the advent of these divergent styles of blankets, came the need for innovation regarding the functionality and utility of a blanket. There have been inventions to address such issues such as: the weighted blanket, which provides an increased sense of security and comfort; the electric blanket, which provides increased warmth and speed of reaching desired temperature; the poncho or more modern Snuggie, which provides wearability and increased transportability; the fire blanket, which has flame extinguishing properties and flame resistance; etc. However, there currently is an overwhelming need and a lack of innovation to improve blanket functionality in aspects that allow it to expand or reduce in size with ease to accommodate different situations. Presently, the blanket is restricted to smaller and standard applications due to the limitations of its size and shape. Solutions for a modular and compartmentalized blanket are needed for this exact purpose.

U.S. Pub. No. [INSERT HERE] to Paul Pham Hoang relates to such a modular and compartmentalized blanket apparatus. The described present invention includes a blanket having zippers on at least two sides of the edges allowing a second blanket having the same two sides of zippers to be joined alongside it. In one embodiment, additional buttons are installed above and below the zipper line to allow the two buttons to join, thereby securely folding the blanket to cover the zipper when not in use. In yet another embodiment, buttons are installed in place of zippers, so that they can be joined with buttons of another blanket to thereby connect the blankets as necessary. The embodiments and illustrations mentioned herein are intended to be merely illustrative of the present invention, and not limiting thereof in scope or in spirit.

### SUMMARY OF INVENTION

In view of the foregoing absence of modular capability in the blanket industry, this present invention provides a novel blanket system that allows blankets to accommodate a multitude of new situations. Moreover, it allows blankets to be customized to fit hard to reach areas and those in which a single blanket could not cover. Further, it provides a solution for the need for large blankets which cannot be transported easily, as this invention allows the user to assemble and disassemble parts of a blanket in order to pack it, and thus, transport it more easily. Such an invention could allow items such as large fire blankets to be packed away in compact spaces without the need for extensive folding.

In this specific embodiment, this invention allows for light or medium thickness blankets of varying material to be joined together. Adjacent blanket materials are joined together via buttons or zippers, allowing for the user to securely fasten the material together to create one cohesive blanket. In some embodiments, the blankets could be attached by velcro technology, allowing for quick and easy access in exchange for the strength of its holding capability. In other embodiments, the blankets could be attached by tying lace or cloth knots together.

[Could add another paragraph here, about application of certain adjoinings to create pockets]

### BRIEF DESCRIPTION OF THE INVENTION

The figures which accompany the written portion of this specification illustrate the embodiments and methods of use for the present disclosure, a modular blanket system and method, constructed and operative according to the teachings of the present disclosure.

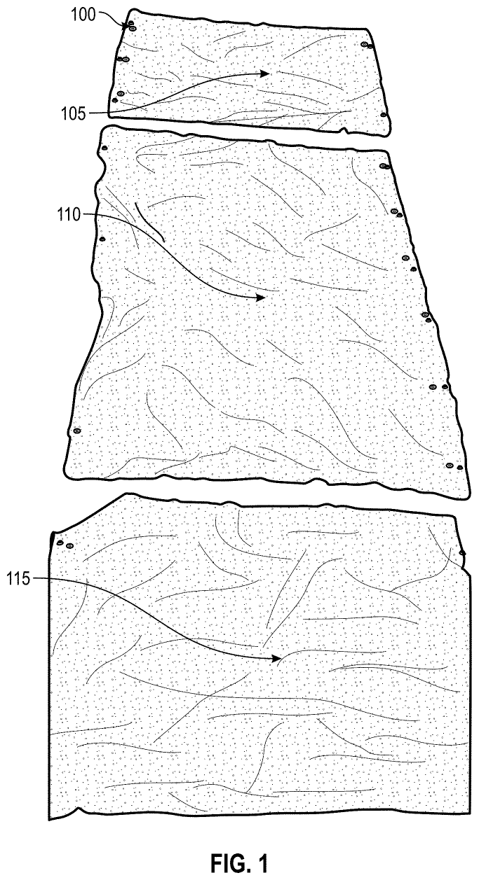

FIG. 1 depicts the button fitted modular blanket fully disassembled, showcasing the buttons aligned on the sides of the blanket.

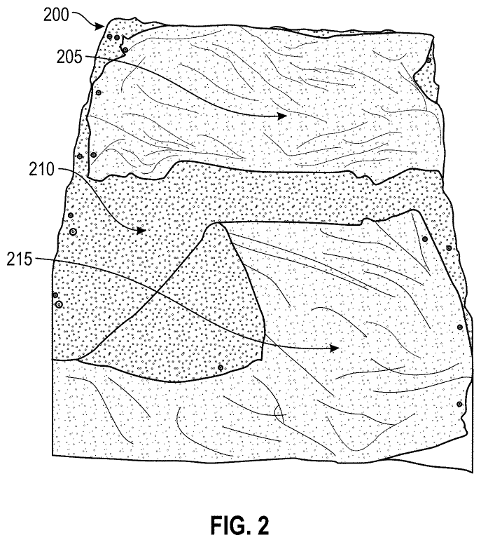

FIG. 2 depicts the button fitted modular blanket fully assembled, according to an embodiment of this disclosure.

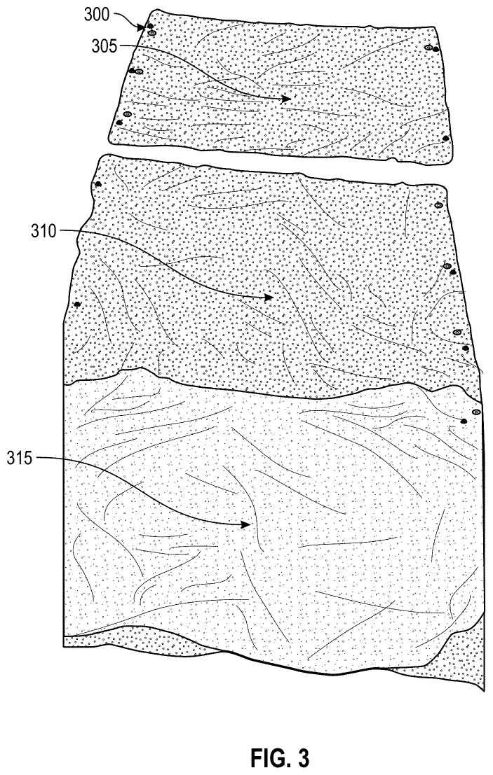

FIG. 3 depicts the button fitted modular blanket assembled only on its bottom side, leaving the top side unassembled, according to an embodiment of the disclosure.

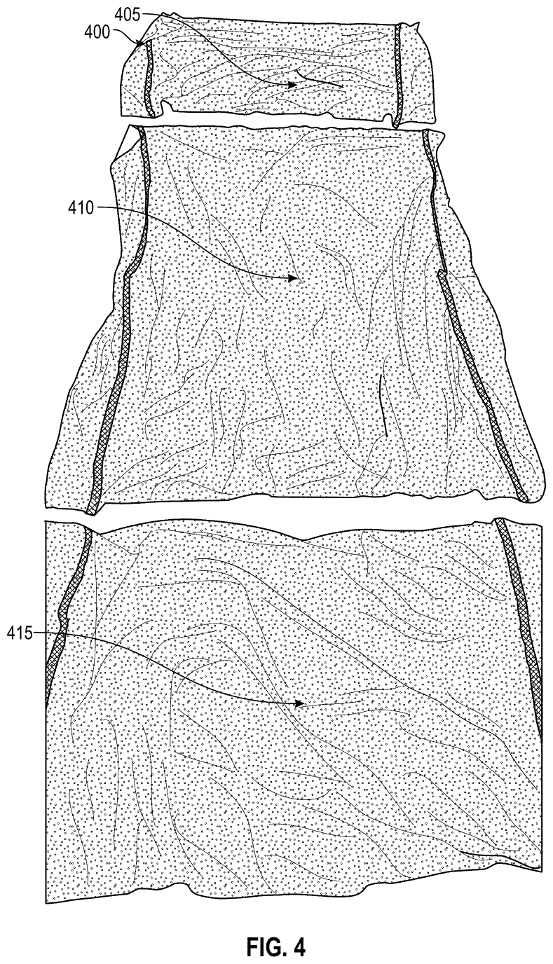

FIG. 4 depicts the zipper fitted modular blanket fully disassembled, showcasing the zippers aligned on the sides of the blanket.

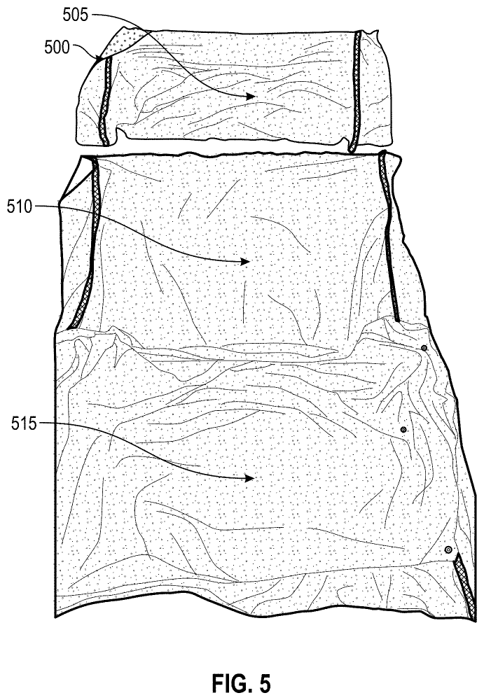

FIG. 5 depicts the zipper fitted modular blanket assembled only on its bottom side, leaving the top side unassembled, according to an embodiment of the disclosure.

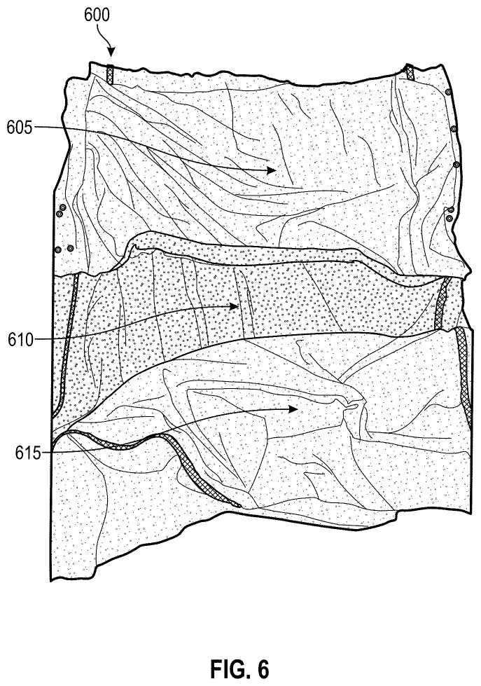

FIG. 6 depicts the zipper fitted modular blanket fully assembled, according to an embodiment of the disclosure.

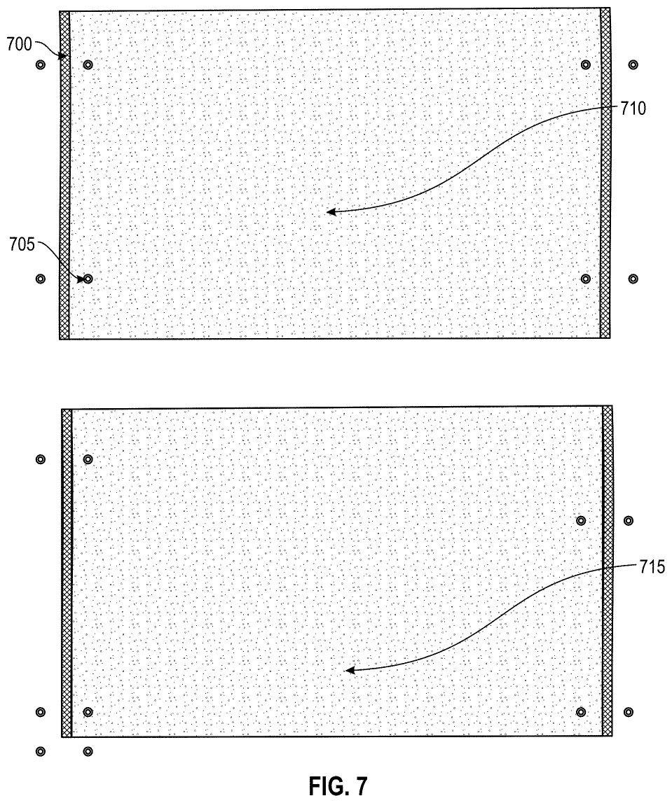

FIG. 7 depicts a drawn design schematic illustrating the components of the modular blanket system, including button or zipper locations, according to an embodiment of this disclosure.

### DETAILED DESCRIPTION OF THE INVENTION

This disclosure is not limited to the particular systems, devices, methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the terms “comprising”, “including”, and/or “such as” mean “including, but not limited to.”

A “user” refers to one or more entities or people using any of the components and/or elements thereof described herein. In some embodiments, the user may be a layperson using a standard modular blanket for warmth or sleeping. In other embodiments, the user may be a public entity, such as a police station or a fire station, using a specific modular blanket for official use purposes.

FIG. 1 depicts the unassembled modular blanket fitted with buttons 100 aligning the lateral sides of the blanket. In some embodiments, the buttons may align on superior and inferior sides of the blanket to allow for additional linking or joining capabilities. In this specific embodiment, the topmost half blanket material 105 may be joined via button connection with the center full blanket material 110. Likewise, the center full blanket material 110 may be joined via button connection with the bottom half blanket material 115. Further, in some embodiments, it may be possible for the same blanket material to connect to itself to create a desired pocket, wrap, or pattern. For instance, center blanket material 110 may be lined with buttons on its leftmost side and buttonholes on its leftmost side, allowing for the connection of the two to create a loop, something fitting for a leg hole or an arm hole.

[I can add more here about material types and their relevant & different applications, Also I can add about different fastening mechanisms (buttons, zippers, etc.) I can come up with more if need be too.]

FIG. 2 depicts the same modular blanket fitted with buttons 100 aligning the lateral sides of the blanket. The blanket shown in the image is fully assembled using the button modifications 200 attached. Here, the top half blanket 205 and the bottom half blanket 215 are folded inwards towards the center blanket material 210 to create a loop. The buttons 200 aligning the sides of the bottom half blanket 215 are arranged to be placed into the button holes of the center blanket material 210 as the fastening mechanism for the modular blanket system. Likewise, the buttons 200 on the top half blanket 205 function similarly by being arranged to be placed into the button holes of the center blanket material 210 to create a loop.

FIG. 3 depicts the same modular blanket fitted with buttons 300 aligning the lateral sides of the blanket. The blanket shown in the image is partially assembled using the button modifications 300 attached. Here, the bottom half blanket 315 is folded inwards towards the center blanket material 310 to create a loop. The buttons 300 aligning the sides of the bottom half blanket 315 are arranged to be placed into button holes of the center blanket material 310 as the fastening mechanism for the modular blanket system. Contrarily, the top half blanket 205 is not folded over the center blanket material 310 and is shown to be unbuttoned.

FIG. 4. Depicts the unassembled modular blanket fitted with zippers 400 aligning the lateral sides of the blanket. In some embodiments, the zippers may align on superior and inferior sides of the blanket to allow for additional linking or joining capabilities. In this specific embodiment, the topmost half blanket material 405 may be joined via zipper connection with the center full blanket material 410. Likewise, the center full blanket material 410 may be joined via zipper connection with the bottom half blanket material 415. Further, in some embodiments, it may be possible for the same blanket material to connect to itself to create a desired pocket, wrap, or pattern. For instance, center blanket material 410 may be lined with zippers on its leftmost side and buttonholes on its leftmost side, allowing for the connection of the two to create a loop, something fitting for a leg hole or an arm hole.

[I can add more here about material types and their relevant & different applications, Also I can add about different fastening mechanisms (buttons, zippers, etc.) I can come up with more if need be too.]

FIG. 5 depicts the same modular blanket fitted with zippers 500 aligning the lateral sides of the blanket. The blanket shown in the image is partially assembled using the zipper modifications 500 attached. Here, the bottom half blanket 515 is folded inwards towards the center blanket material 510 to create a loop. The buttons 500 aligning the sides of the bottom half blanket 515 are arranged to be placed into button holes of the center blanket material 510 as the fastening mechanism for the modular blanket system. Contrarily, the top half blanket 505 is not folded over the center blanket material 510 and is shown to be unbuttoned.

FIG. 6 depicts the same modular blanket fitted with zippers 600 aligning the lateral sides of the blanket. The blanket shown in the image is fully assembled using the zipper modifications 600 attached. Here, the top half blanket 605 and the bottom half blanket 615 are folded inwards towards the center blanket material 610 to create a loop. The zippers 600 aligning the sides of the bottom half blanket 615 are arranged to be placed into the zipper holes of the center blanket material 610 as the fastening mechanism for the modular blanket system. Likewise, the zipper 600 on the top half blanket 605 function similarly by being arranged to be placed into the zipper holes of the center blanket material 610 to create a loop.

FIG. 7 depicts a drawn design schematic illustrating the components of the modular blanket system, including button 705 or zipper 700 locations. The schematic displays the top half blanket 710 and the bottom half blanket 715 laying next to each other before assembly of the fastening mechanisms are completed. Accordingly, it shows that both button 705 and zipper 700 fastening mechanisms can be instituted simultaneously, allowing for an increased number of potential uses.

In the above detailed descriptions, reference is made to the accompanying drawings and photos, which form a part hereof. The photos and drawn design schematic are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and Scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the sin gular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open terms (for example, the term “including should be interpreted as “including but not limited to the term “having should be interpreted as “having at least the term “includes should be interpreted as “includes but is not limited to etcetera). While various compositions, methods, and devices are described in terms of “comprising various components or steps (interpreted as meaning “including, but not limited to′), the compositions, methods, and devices can also “consist essentially of or “consist of the various components and steps, and Such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles ‘a’ or “an limits any particular claim containing Such introduced claim recitation to embodiments containing only one Such recitation, even when the same claim includes the introductory phrases “one or more” or “at least one” and indefinite articles such as “a” or “an” (for example, “a” and/or “an should be interpreted to mean “at least one’ or “one or more’); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations.” without other modifiers, means at least two recitations, or two or more recitations). Furthermore, in those instances where a convention analogous to “at least one of A, B, and C, et cetera′ is used, in general Such a construction is intended in the sense one having skill in the art would understand the convention (for example, “a system having at least one of A, B, and C would include but not be limited to systems that have A alone, B alone, C alone, A and B together, A and C together, B and C together, and/or A, B, and C together, et cetera). In those instances where a convention analogous to “at least one of A, B, or C, etcetera” is used, in general such a construction is intended in the sense one having skill in the art would understand the convention (for example, “a system having at least one of A, B, or C would include but not be limited to systems that have A alone, B alone, C alone, A and B together, A and C together, B and C together, and/or A, B, and C together, et cetera). It will be further understood by those within the art that virtually any disjunctive word and/or Mar. 31, 2016 phrase presenting two or more alternative terms, whether in the description, claims, or drawings, should be understood to contemplate the possibilities of including one of the terms, either of the terms, or both terms. For example, the phrase “A or B will be understood to include the possibilities of “A” or B Or A and B.

Various of the above-disclosed and other features and functions, or alternatives thereof, may be combined into many other different systems or applications. Various presently unforeseen or unanticipated alternatives, modifications, variations or improvements therein may be Subsequently made by those skilled in the art, each of which is also intended to be encompassed by the disclosed embodiments.

1, A modular blanket comprising a first portion, a middle portion, and a second portion that are joined together by a plurality fastening means attached to and disposed along edges of said first, middle, and second portions; wherein said plurality fastening means are arranged such that said first, middle, and second portions can fold in halves and said plurality fastening means engage and fasten said halves.

2. The modular blanket of claim 1, wherein said two or more fastening means are disposed on the superior and inferior sides of said first, middle, and second portions.

3. The modular blanket of claim 1, wherein said first portion is folded inwards onto said middle portion; wherein said two or more fastening means engage along edges of said first and middle portions, and, thus, said first portion is fastened to said middle portion.

4. The modular blanket of claim 1, wherein said second portion is folded inwards onto said middle portion; wherein said two or more fastening means engage along edges of said second and middle portions, and, thus, said second portion is fastened to said middle portion.
